(19) United States
(12) Patent Application Publication
(10) Pub. No.: US 2014/0322973 A1
(43) Pub. Date: Oct. 30, 2014

(54) CONNECTOR

(71) Applicant: YAZAKI CORPORATION, Tokyo (JP)

(72) Inventors: Kenichi OKAMOTO, Kakegawa-shi (JP); Toshiyuki NAGASAWA, Kakegawa-shi (JP)

(73) Assignee: YAZAKI CORPORATION, Tokyo (JP)

(21) Appl. No.: 14/261,787

(22) Filed: Apr. 25, 2014

(30) Foreign Application Priority Data
Apr. 26, 2013 (JP) 2013-094466

(51) Int. Cl. H01R 13/52

(52) U.S. Cl. CPC H01R 13/5205
USPC 439/587

(57) ABSTRACT

A connector includes a housing, a terminal, a seal holder and fastening piece. The terminal is inserted into a terminal passing hole and a seal mounting hole of the housing and passes through an annular seal member. The terminal has a protruding tip part having a fastening hole and protruding from an outer surface of the housing. The seal holder includes a press fitting protrusion that is fit into the seal mounting hole and thereby pushes in and positions the annular seal member, a terminal leading hole that leads the terminal inserted into the press fitting protrusion, and an engagement recess that is formed at a leading end side of the terminal leading hole and is opened in a direction perpendicular to the leading direction of the terminal leading hole.

### BACKGROUND

The present invention relates to a connector having a configuration that influx of liquid such as water and oil into a housing is avoided.

For example, in an electric vehicle, a connector (a terminal block) for electrically connecting an inverter and a motor to each other is known.

In a terminal block 501 shown in FIGS. 7A to 7C, a bus bar 503 serving as a terminal is connected to each contact element (not shown) of the motor and the inverter with a nut and bolt (a fastening piece) and then energized. The bus bar 503 is held in a manner of going through the housing 505. In the housing 505, a motor side flange 507 and an inverter side flange 509 are formed in parallel to each other. The motor side flange 507 and the inverter side flange 509 are attached respectively to a motor side mounting hole formed in a panel on the motor side and an inverter side mounting hole formed in a panel on the inverter side. A motor side packing 511 and an inverter side packing 513 are mounted onto the motor side flange 507 and the inverter side flange 509, respectively. An O-ring 517 is mounted into the O-ring mounting hole 515 of the housing 505. Then, the O-ring 517 serving as an annular seal member seals in a liquid-tight manner between the bus bar 503 and the O-ring mounting hole 515. This avoids water influx into the equipment and oil leakage from the equipment.

Nevertheless, in the terminal block 501 having the above-mentioned configuration, after the O-ring 517 is mounted onto the bus bar 503, when inclination or deformation occurs as shown in FIGS. 8A and 8B, a compression allowance is not ensured in the O-ring 517 and hence a possibility of water influx or oil leakage arises.

Thus, a connector has been proposed in which a satisfactory effect of avoiding liquid influx is maintained (for example, see JP-A-2012-243636).

As shown in FIGS. 9A and 9B, this connector 521 includes: a housing 525 provided with a terminal insertion hole 523; a terminal 527 (a member equivalent to the above-mentioned bus bar 503) inserted into the terminal insertion hole 523; an O-ring 517 attached such as to enclose the entire circumference of the terminal 527 so as to block a gap between the terminal insertion hole 523 and the terminal 527; a nut 529 for fastening and fixing a counterpart terminal to the terminal 527; and an O-ring holder 531 pressed toward the O-ring side by the nut 529 so as to press the O-ring 517 against a gap between the terminal insertion hole 523 and the terminal 527.

Nevertheless, the above-mentioned connector 521 requires insertion of the O-ring holders 531 in a number equal to the number of poles (six poles in this example) and insertion of the nuts 529 in a number equal to the number of poles. This causes complexity in the assembling work. Further, the nut 529 need have a press fitting configuration in order to avoid dropping and need be press-fit to a fastening position with precision along the direction of mounting of the O-ring holder 531. When the press fitting precision of the nut 529 is unsatisfactory, the fastening holes 533 of the nut 529 and the terminal 527 do not agree with each other and hence workability of terminal connection is degraded. Further, on the tip part side of the terminal 527, the O-ring holder 531 is attached in the surroundings thereof. Thus, this side cannot directly be held by the housing 525. This has caused a problem that a positional accuracy and a holding force are not sufficiently ensured in the terminal 527.

### SUMMARY

The present invention has been devised in view of the above-mentioned situation. An object thereof is to provide a connector in which a high sealing property is ensured and the terminal and the fastening piece are positioned and held with precision.

The above-mentioned object of the present invention is achieved by the following configurations.

(1) A connector comprising:

a housing having a terminal passing hole and a seal mounting hole which is communicated with the terminal passing hole, wherein an annular seal member is mounted in the seal mounting hole;

a terminal which is inserted into the terminal passing hole and the seal mounting hole and which passes through the annular seal member; wherein the terminal has a protruding tip part protruding from an outer surface of the housing, the protruding tip part having a fastening hole;

a seal holder which includes a press fitting protrusion that is fit into the seal mounting hole and thereby pushes in and positions the annular seal member, a terminal leading hole that leads the terminal inserted into the press fitting protrusion, and an engagement recess that is formed at a leading end side of the terminal leading hole and is opened in a direction perpendicular to the leading direction of the terminal leading hole; and

a fastening piece which is arranged in the engagement recess for fastening and fixing a counterpart terminal to the fastening hole of the terminal in a state that the terminal is led through the terminal leading hole to the engagement recess.

According to the connector having the above-mentioned configuration (1), a protruding end of the terminal having a fastening hole protrudes through the seal mounting hole opened in the housing outer surface. The terminal goes through the annular seal member in the inside of the seal mounting hole. The annular seal member seals in a liquid-tight manner the gap between the terminal and the seal mounting hole.

A seal holder is attached to the housing outer surface from which the protruding end of the terminal protrudes. The seal holder has a press fitting protrusion fit into the seal mounting hole opened in the housing outer surface. Then, when the press fitting protrusion of the seal holder is inserted into the seal mounting hole, in the terminal inserted into the inner side of the press fitting protrusion, the fastening hole is led through the terminal leading hole to the engagement recess. In the engagement recess, the fastening piece is arranged for fastening and fixing the counterpart terminal to the terminal. Thus, the terminal is fastened and fixed to the counterpart terminal by the fastening piece.

Here, when the seal holder is attached to the housing, the terminal protruding through the seal mounting hole of the housing is inserted into the terminal leading hole of the press fitting protrusion simultaneously inserted into the seal mounting hole, so that positional deviation relative to the housing and backlash in each terminal are corrected. This ensures a satisfactory positional accuracy and a satisfactory holding force in the terminal.

At the same time, the tip of the press fitting protrusion presses the annular seal member deep into the seal mounting hole so that inclination of the annular seal member is suppressed and hence the annular seal member is stored at a regular position in the seal mounting hole. Thus, a high sealing property is ensured in the gap between the seal mounting hole and the terminal and hence water influx and oil leakage are avoided.

Further, in a case that the housing has a plurality of terminal passing holes and the seal holder has a plurality of press fitting protrusions and terminal leading holes, when the seal holder is attached to the housing, in each terminal, positional deviation relative to the housing and backlash in each terminal are corrected and, at the same time, positional deviation between the plurality of terminals is corrected.

(2) In the connector having the above-mentioned configuration (1), the fastening piece is fit into a fastening piece fitting part formed on a bottom face of the engagement recess, the fastening piece fitting part having recessed shape.

According to the connector having the above-mentioned configuration (2), when the seal holder is attached to the housing, the upper part of the fastening piece attached to the fastening piece fitting part cut in the bottom face of the engagement recess is covered by the protruding end of the terminal having been led through the terminal leading hole to the engagement recess. Thus, the fastening piece pinched by the seal holder and the terminal is arranged in the engagement recess of the seal holder without backlash and, at the same time, dropping from the seal holder is avoided. As a result, the center of the fastening hole of the terminal and the axial center of the fastening piece agree with each other with precision and hence the work of fastening and fixing becomes easy.

(3) In the connector having the above-mentioned configuration (1) or (2), the press fitting protrusion is formed in an annular shape so as to push the annular seal member over an entire circumference of the terminal into the seal mounting hole.

According to the connector having the above-mentioned configuration (3), the press fitting protrusion formed in an annular shape in the seal holder presses the annular seal member over the entire circumference of the terminal with satisfactory balance. Thus, a more satisfactory sealing condition is ensured in the sealing of the gap between the seal mounting hole and the terminal performed by the annular seal member.

According to the connector of the present invention, a high sealing property is ensured and, at the same time, the terminal and the fastening piece can be positioned and held with precision.

The present invention has briefly been described above. Further, when the mode of implementing the present invention (referred to as “embodiments”, hereinafter) described below is read thoroughly with reference to the accompanying drawings, details of the present invention will become clearer.

### BRIEF DESCRIPTION OF THE DRAWINGS

FIG. 1 is a perspective view of a connector according to an embodiment of the present invention.

FIG. 2 is a front view of a connector shown in FIG. 1, viewed from the motor side.

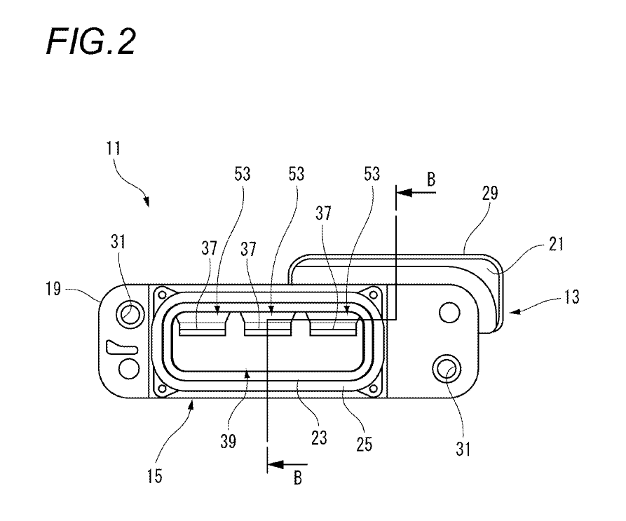

FIG. 3 is a sectional view taken along line B-B in FIG. 2.

FIG. 4 is a perspective view of a seal holder shown in FIG. 1.

FIG. 5A is an exploded perspective view of a connector in a state that a seal holder is not yet mounted. FIG. 5B is a plan view of a connector in a state that a seal holder has been mounted.

FIG. 6A is an enlarged sectional view of a vicinity of a press fitting protrusion of a connector shown in FIG. 3. FIG. 6B is an enlarged view of a main part of part (a).

FIG. 7A is a perspective view of a connector of the conventional art. FIG. 7B is a front view of a connector shown in part (a), viewed from the motor side. FIG. 7C is a sectional view taken along line A-A in part (b).

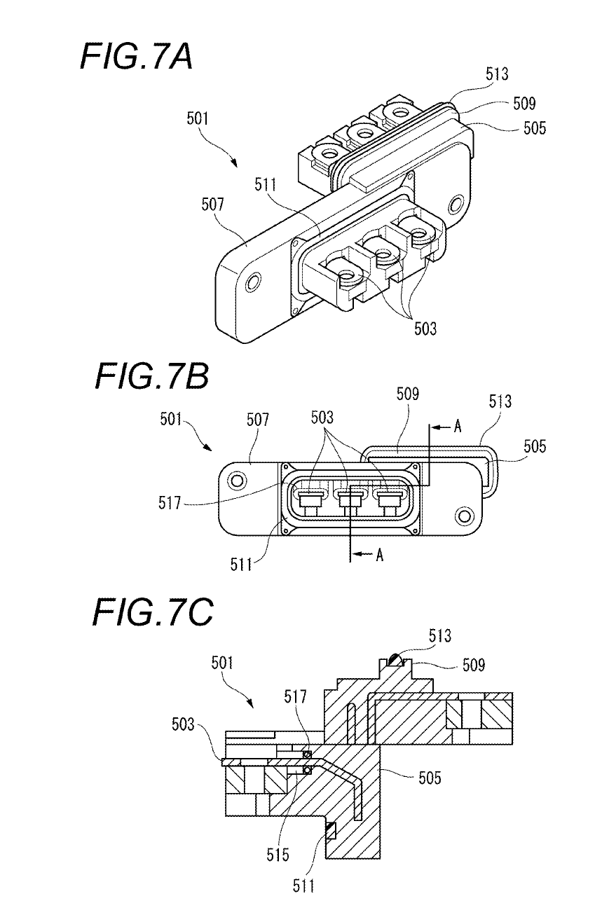

FIG. 8A is an enlarged sectional view of a vicinity of an O-ring of a connector shown in FIG. 7C. FIG. 8B is a perspective view showing a situation of torsion of an O-ring.

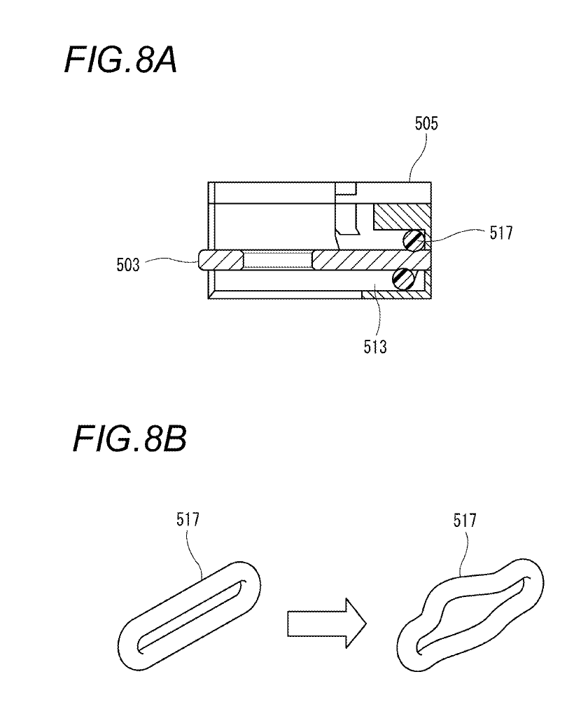

FIG. 9A is a perspective view of a connector provided with an O-ring holder in the conventional art. FIG. 9B is an enlarged perspective view of a main part of a connector shown in part (a) in a situation that a part thereof is cut off.

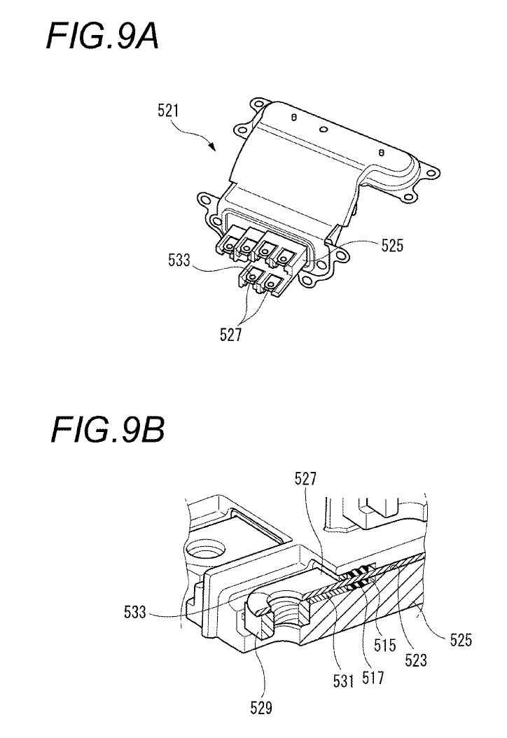

### DETAILED DESCRIPTION OF EXEMPLARY EMBODIMENTS

Embodiments of the present invention are described below with reference to the drawings.

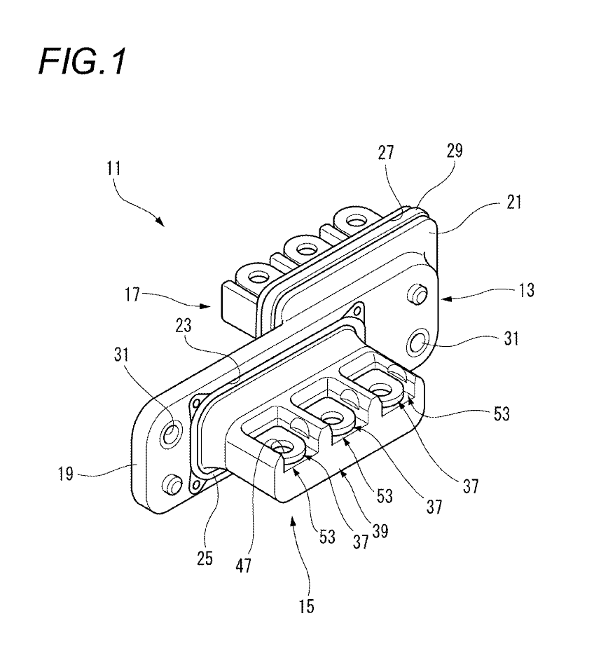

As shown in FIG. 1, a connector 11 according to an embodiment of the present invention is mounted onto a motor side panel (not shown) and an inverter side panel (not shown).

The connector 11 includes a housing 13 (also referred to as a terminal block) formed from synthetic resin having an insulation property. The housing 13 is provided with a motor side connection part 15 at a mounting side mounting to the motor-side-panel. The housing 13 is provided with an inverter side connection part 17 at a mounting side mounting to the inverter-side-panel.

In the housing 13, a motor side flange 19 and an inverter side flange 21 are formed in parallel to each other. The motor side flange 19 and the inverter side flange 21 are attached to a motor side mounting hole (not shown) formed in a panel on the motor side and an inverter side mounting hole (not shown) formed in a panel on the inverter side.

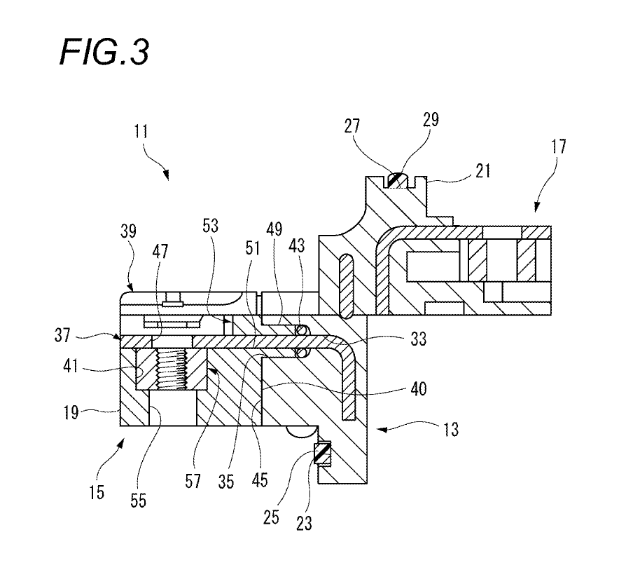

In the motor side flange 19, a motor side seal groove 23 is formed around the motor side connection part 15. Then, a motor side packing 25 having annular shape is fit into the motor side seal groove 23 (see FIG. 3). In the outer periphery of the inverter side flange 21, an inverter side seal groove 27 is formed. Then, an inverter side packing 29 having annular shape is fit into the inverter side seal groove 27.

At the time of mounting the connector 11 according to the present embodiment onto the motor side panel, the motor side connection part 15 of the housing 13 is pushed into the motor side mounting hole and the motor side flange 19 abuts against the panel surface in the edge part of the motor side mounting hole. In this state, an attachment screw (not shown) is inserted into a fixing bolt insertion hole 31 of the motor side flange 19 and then screwed into a screw hole (not shown) formed in the motor side panel.

By virtue of this, the connector 11 is fixed and attached to the motor side panel. As such, when the connector 11 is fixed to the motor side panel, the motor side packing 25 goes into close contact with the motor side panel so that sealing is achieved between the motor side panel and the connector 11.

Next, the motor side connection part 15 of the housing 13 is described below. Here, main constituting parts of the present invention are applied to the motor side connection part 15. Thus, detailed description is omitted for the inverter side connection part 17.

The motor side connection part 15 includes: a terminal passing hole 33 (see FIG. 3), an O-ring (an annular seal member) 43, an O-ring mounting hole (a seal mounting hole) 35, a terminal 37, an O-ring holder (a seal holder) 39, an engagement recess 53, and a square nut (a fastening piece) 57.

In the housing 13 in the motor side connection part 15, a plurality (three, in the present embodiment) of the terminal passing holes 33 are formed. Then, on the near side relative to the terminal passing hole 33 in the housing 13, the O-ring mounting hole 35 having a larger cross section than the terminal passing hole 33 is formed. The O-ring mounting hole 35 is communicated with the terminal passing hole 33. The O-ring 43 is inserted into the O-ring mounting hole 35.

The terminals 37 are formed from electrically conductive metal material such as copper. The terminals 37 are inserted into respective terminal passing holes 33 and go through the center opening of the O-ring 43. The terminal 37 having passed through the O-ring 43 has a fastening hole 47 in a protruding tip part protruding from the housing outer surface 45 (see FIG. 3) through the O-ring mounting hole 35.

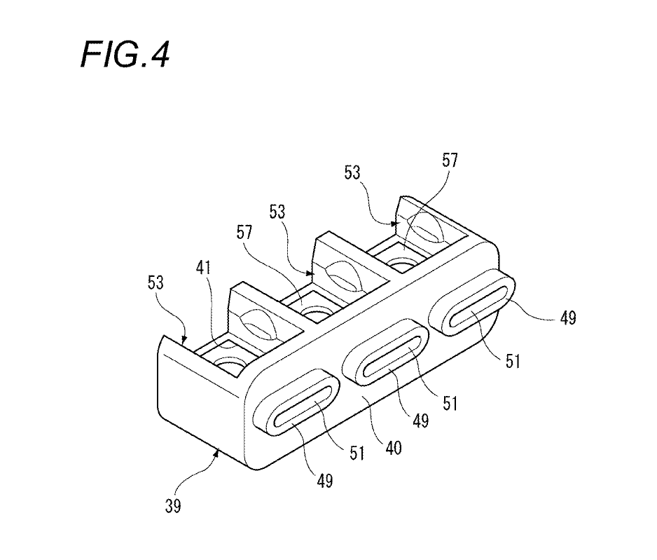

The O-ring holder 39 includes a plurality of annular fitting protrusions (press fitting protrusions) 49 (see FIG. 4) each fit into the O-ring mounting hole 35 so as to push in and position each O-ring 43, and a terminal leading hole 51 for leading the terminal 37 inserted into the inner side of the annular fitting protrusion 49. The annular fitting protrusion 49 is formed in an annular shape for pushing in the O-ring 43 over the entire circumference of the terminal 37. On the near side relative to the O-ring mounting hole 35 in the housing 13, the engagement recess 53 is provided whose upper side is opened by forming a notch. That is, the engagement recess 53 is formed in the O-ring holder 39 such that the leading end side of the terminal leading hole 51 is opened in a direction perpendicular to the leading direction. A nut fitting part (a fastening piece fitting part) 41 is further cut in the bottom face of the engagement recess 53. Then, a bolt clearance hole 55 is formed under the nut fitting part 41. The fastening hole 47 of the terminal 37 is arranged in the engagement recess 53.

In the terminal 37 inserted through the terminal passing hole 33 to the O-ring mounting hole 35, the O-ring 43 of annular shape is mounted from the tip side. The terminal passing hole 33 and the terminal 37 are in close contact with each other by press fitting, insert molding, or the like, but not in a water-tight state that capillary action is avoided. The O-ring 43 is formed from elastic material such as rubber and mounted on the terminal 37 such as to enclose the entire circumference of the terminal 37. By virtue of this, the gap between the terminal 37 and the O-ring mounting hole 35 is sealed in a water-tight manner by the O-ring 43.

The O-ring holder 39 according to the present embodiment is fabricated from synthetic resin by integral molding. In the annular fitting protrusion 49 of the O-ring holder 39, the cross sectional shape thereof in a direction perpendicular to the axis agrees with the cross sectional shape of the O-ring mounting hole 35. Thus, when the O-ring holder 39 is attached to the housing 13, the annular fitting protrusion 49 is inserted (fit) into the O-ring mounting hole 35 without backlash. Further, in the terminal 37, the cross sectional shape thereof in a direction perpendicular to the longitudinal direction agrees with the cross sectional shape of the terminal leading hole 51. Thus, the terminal 37 is fit into the terminal leading hole 51 without backlash.

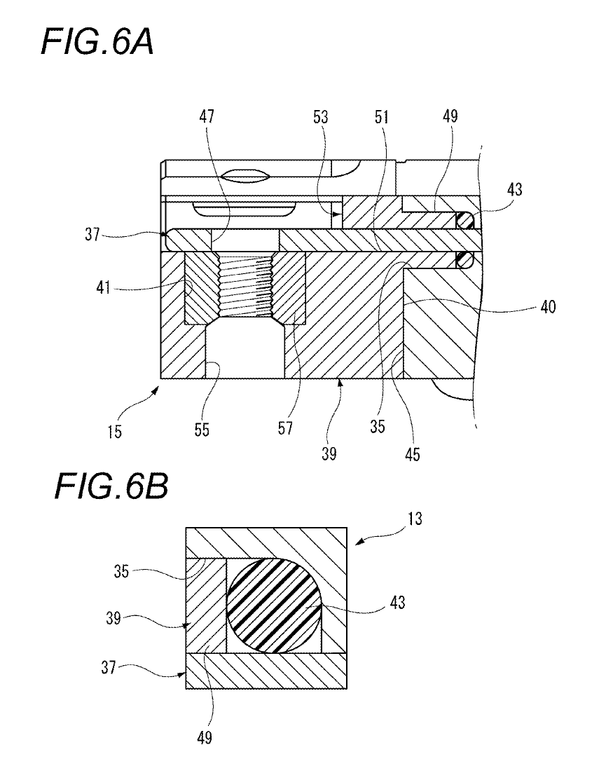

In the O-ring holder 39, in a state that the terminal 37 is inserted through the terminal leading hole 51 of the annular fitting protrusion 49, the annular fitting protrusion 49 is pushed in to the O-ring side. As shown in FIGS. 6A and 6B, the tip of the annular fitting protrusion 49 abuts against the O-ring 43 fit into the O-ring mounting hole 35. In the O-ring holder 39 pushing in the O-ring 43, mounting is completed when the holder outer surface 40 abuts against the housing outer surface 45. At the position of mounting completion of the O-ring holder 39, the annular fitting protrusion 49 positions the O-ring 43 at a regular position in the pushing direction.

Further, in the nut fitting part 41 of the engagement recess 53, the square nut 57 is fit in from the above of the O-ring holder 39. In the present embodiment, the square nut 57 is press-fit and fixed to the nut fitting part 41 having a rectangular shape. Here, it is not indispensable that the square nut 57 is press-fit and fixed to the nut fitting part 41. The square nut 57 is attached to the nut fitting part 41 and then arranged such as to be coaxial to the fastening hole 47 of the terminal 37 led through the terminal leading hole 51 to the engagement recess 53.

Next, operation of the connector 11 having the above-mentioned configuration is described below.

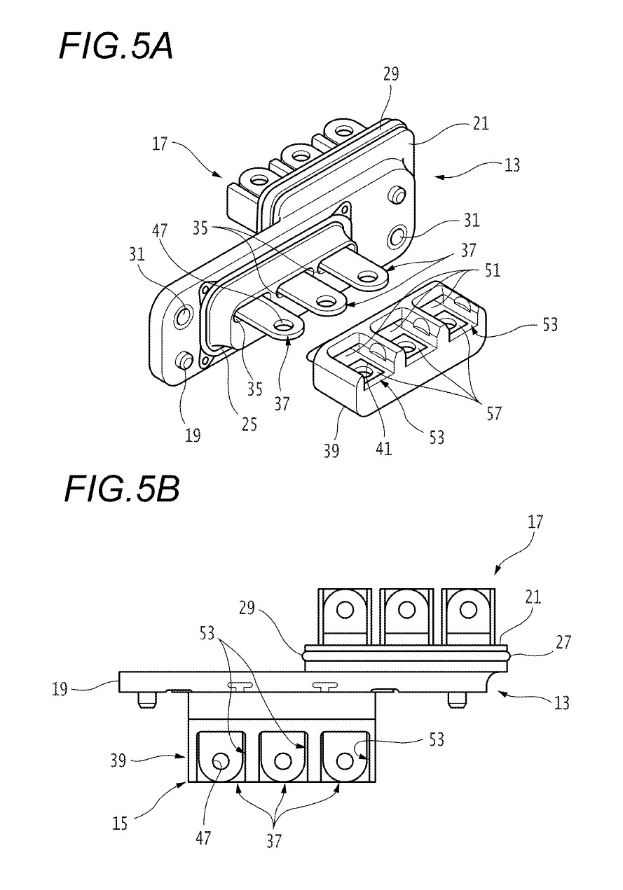

In the connector 11 according to the present embodiment, as shown in FIG. 5A, the protruding end of each of the terminals 37 having the fastening hole 47 protrudes through each O-ring mounting hole 35 opened in the housing outer surface 45. In this state, as shown in FIGS. 6A and 6B, the terminal 37 goes through the center opening of the O-ring 43 in the inside of the O-ring mounting hole 35. The O-ring 43 seals in a liquid-tight manner the gap between the terminal 37 and the O-ring mounting hole 35.

The O-ring holder 39 is attached to the housing outer surface 45 from which the protruding end of the terminal 37 protrudes. The O-ring holder 39 is attached to the housing 13 by fitting the annular fitting protrusions 49 into the O-ring mounting holes 35 opened in the housing outer surface 45. Thus, in the O-ring holder 39, the plurality of annular fitting protrusions 49 are collectively fit into the plurality of O-ring mounting holes 35. Thus, even in a case of multiple poles, one time of the work of attachment to the housing 13 is sufficient. When the annular fitting protrusions 49 of the O-ring holder 39 are inserted into the O-ring mounting holes 35, in the terminals 37 inserted into the inner side of the annular fitting protrusions 49, the fastening holes 47 are led through the terminal leading holes 51 to the engagement recesses 53. In the engagement recesses 53, the square nuts 57 are arranged respectively for fastening and fixing the counterpart terminals (not shown) to the terminals 37. Then, when a bolt having passed through the counterpart terminal goes through each of the fastening holes 47 and then is fastened to the square nut 57, each of the terminals 37 is tightened together with the counterpart terminal so as to be fastened and fixed.

Here, when the O-ring holder 39 is attached to the housing 13, the plurality of terminals 37 protruding through the O-ring mounting holes 35 are inserted into the terminal leading holes 51 of the annular fitting protrusions 49 simultaneously inserted into the plurality of O-ring mounting holes 35, so that positional deviation relative to the housing 13, positional deviation between the terminals, and backlash in each terminal are corrected. This ensures a satisfactory positional accuracy and a satisfactory holding force in the terminals 37.

At the same time, as shown in FIG. 6B, the tip of each of the annular fitting protrusions 49 presses the O-ring 43 deep into the O-ring mounting hole 35 so that inclination of the O-ring 43 is suppressed and hence the O-ring 43 is stored at a regular position in the O-ring mounting hole 35. Thus, a high sealing property is ensured in the gap between the O-ring mounting hole 35 and the terminal 37 and hence water influx and oil leakage are avoided.

Then, the counterpart terminal on the equipment side is connected to each of the terminals 37 located at the engagement recesses 53. This counterpart terminal is provided with a bolt insertion hole. When the counterpart terminal is to be connected to each of the terminals 37, the bolt insertion hole of the counterpart terminal is aligned with the fastening hole 47 of each of the terminals 37. In this state, each of bolts is inserted into the bolt insertion hole and the fastening hole 47, then screwed into the square nut 57, and then tightened. The tip part of the bolt protruding from the lower part of the square nut 57 does not interfere with the housing 13 and enters the clearance hole 55 formed under the nut fitting part 41.

Thus, by virtue of the fastening force between the square nut 57 and the bolt, the counterpart terminal is firmly connected to the terminal 37 and hence satisfactory connection reliability is ensured.

Further, in the connector 11 according to the present embodiment, when the O-ring holder 39 is attached to the housing 13, in the square nut 57 attached to the nut filling part 41 cut in the bottom face of the engagement recess 53, the upper part thereof is covered by the protruding end of the terminal 37 having been led through the terminal leading hole 51 to the engagement recess 53. Thus, the square nut 57 pinched by the O-ring holder 39 and the terminal 37 is arranged in the engagement recess 53 of the O-ring holder 39 without backlash and, at the same time, dropping from the O-ring holder 39 is avoided. As a result, the center of the fastening hole 47 of the terminal 37 and the axial center of the square nut 57 agrees with each other with precision and hence the work of fastening and fixing becomes easy.

Thus, according to the connector 11 of the present embodiment, high sealing property is ensured and, at the same time, the terminal 37 and the square nut 57 can be positioned and held with precision.

Here, the present invention is not limited to the embodiments described above. That is, modifications, improvements, or the like may be made appropriately. Further, the construction material, the shape, the dimension, the number, the arrangement location, and the like of each component in the embodiments described above are arbitrary and not limited as long as the present invention can be implemented.

For example, in the above-mentioned embodiments, the O-ring 43 has been employed as the annular seal member. Obviously, any other annular seal member of diverse kind such as an X-ring and a D-ring may be employed.

Further, as for the square nut 57 employed as the fastening piece, the employment is not limited to this. That is, any other fastening piece such as a hexagonal nut may be employed.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2013-094466 filed on Apr. 26, 2013, the contents of which are incorporated herein by reference.

What is claimed is:

1. A connector comprising:
a housing having a terminal passing hole and a seal mounting hole which is communicated with the terminal passing hole, wherein an annular seal member is mounted in the seal mounting hole;
a terminal which is inserted into the terminal passing hole and the seal mounting hole and which passes through the annular seal member; wherein the terminal has a protruding tip part protruding from an outer surface of the housing, the protruding tip part having a fastening hole;
a seal holder which includes a press fitting protrusion that is fit into the seal mounting hole and thereby pushes in and positions the annular seal member, a terminal leading hole that leads the terminal inserted into the press fitting protrusion, and an engagement recess that is formed at a leading end side of the terminal leading hole and is opened in a direction perpendicular to the leading direction of the terminal leading hole; and
a fastening piece which is arranged in the engagement recess for fastening and fixing a counterpart terminal to the fastening hole of the terminal in a state that the terminal is led through the terminal leading hole to the engagement recess.

2. The connector according to claim 1, wherein the fastening piece is fit into a fastening piece fitting part formed on a bottom face of the engagement recess, the fastening piece fitting part having recessed shape.

3. The connector according to claim 1, wherein the press fitting protrusion is formed in an annular shape so as to push the annular seal member over an entire circumference of the terminal into the seal mounting hole.
